(19) United States
(12) Patent Application Publication
(10) Pub. No.: US 2012/0092764 A1
(43) Pub. Date: Apr. 19, 2012

(54) Stereoscopic glasses

(75) Inventors: Hironobu Fukutomi, Yokosuka-shi (JP); Kazutaka Aboshi, Yokohama-shi (JP); Tadashi Furukawa, Yokosuka-shi (JP)

(73) Assignee: JVC KENWOOD Corporation, Kanagawa (JP)

(21) Appl. No.: 13/200,709

(22) Filed: Sep. 29, 2011

(30) Foreign Application Priority Data
Oct. 19, 2010 (JP) 2010-234745

(51) Int. Cl. G02B 27/26

(52) U.S. Cl. 359/465

(57) ABSTRACT

Stereoscopic or 3D glasses include a half-wave phase difference plate, a first polarization-converting optical system, and a second polarization-converting optical system. The half-wave phase difference plate is movable between a used position and an unused position. The first polarization-converting optical system follows the half-wave phase difference plate when the half-wave phase difference plate is in its used position. The first polarization-converting optical system is uncovered when the half-wave phase difference plate is in its unused position. When the half-wave phase difference plate is in its used position, the glasses operate in a two-dimensionally viewing mode. When the half-wave phase difference plate is in its unused position, the glasses operate in a three-dimensionally viewing mode.

### BACKGROUND OF THE INVENTION

1. Field of the Invention

This invention generally relates to stereoscopic or 3D (three-dimensional) glasses for enabling a user to view 2D (two-dimensional) pictures as 3D pictures. This invention particularly relates to stereoscopic or 3D glasses easily changeable between a 3D mode of operation that enables 2D pictures to be viewed as 3D pictures and a 2D mode of operation that causes 2D pictures to be viewed as they are.

2. Description of the Related Art

In recent years, picture theaters have shown 3D movies. Generally, spectators in movie theaters need to wear stereoscopic or 3D glasses to have 3D illusions from 2D pictures. Although 3D visions are powerful than original 2D visions, 3D movies have a problem of causing some spectators to get 3D sick. Typical symptoms of 3D sickness are headache and giddiness. It is better to replace 3D visions presented to a spectator, who is suffering from 3D sickness, by original 2D visions.

Japanese patent application publication number 10-239641/1998 discloses polarizing glasses for 3D visions which include a polarizing plate for a right eye and a polarizing plate for a left eye. The polarizing glasses further include phase modulators and drive units. The phase modulators are arranged on the light incidence sides of the right-eye polarizing plate and the left-eye polarizing plate, respectively. The drive units can selectively apply voltages to the phase modulators to control them. In the absence of the voltages applied to the phase modulators, the polarizing glasses pass right-eye image light to user's right eye only and pass left-eye image light to user's left eye only. Thus, in this case, 3D images are observed by the user. In the case where the drive units alternately apply the voltages to the phase modulators on a time sharing basis, the polarizing glasses pass right-eye image light to both user's right and left eyes and pass left-eye image light to both user's right and left eyes. Thus, in this case, 2D images are observed by the user. Accordingly, it is possible for the user to arbitrarily select viewing 3D images or viewing 2D images through the operation of the drive units.

In the polarizing glasses of Japanese application 10-239641/1998, the phase modulators are formed by ferroelectric liquid crystal devices which are expensive. Thus, the polarizing glasses of Japanese application 10-239641/1998 are high in cost.

### SUMMARY OF THE INVENTION

It is an object of this invention to provide inexpensive stereoscopic or 3D glasses which enable a user to arbitrarily select viewing 3D images or viewing 2D images.

A first aspect of this invention provides stereoscopic glasses comprising a half-wave phase difference plate movable between a used position and an unused position and reversing a rotational direction of polarization of first circularly polarized light and a rotational direction of polarization of second circularly polarized light to generate third circularly polarized light and fourth circularly polarized light respectively, wherein the rotational direction of polarization of the first circularly polarized light and the rotational direction of polarization of the second circularly polarized light are opposite to each other; a first polarization-converting optical system exposed to the third circularly polarized light and the fourth circularly polarized light and converting the third circularly polarized light and the fourth circularly polarized light into first linearly polarized light and second linearly polarized light respectively and blocking the first linearly polarized light and outputting the second linearly polarized light when the half-wave phase difference plate is in its used position, and exposed to the first circularly polarized light and the second circularly polarized light and converting the first circularly polarized light and the second circularly polarized light into third linearly polarized light and fourth linearly polarized light respectively and blocking the fourth linearly polarized light and outputting the third linearly polarized light when the half-wave phase difference plate is in its unused position; and a second polarization-converting optical system converting the first circularly polarized light and the second circularly polarized light into fifth linearly polarized light and sixth linearly polarized light respectively and blocking the fifth linearly polarized light and outputting the sixth linearly polarized light.

A second aspect of this invention is based on the first aspect thereof, and provides stereoscopic glasses wherein each of the first polarization-converting optical system and the second polarization-converting optical system comprises a quarter-wave phase difference plate and a polarizer following the quarter-wave phase difference plate.

A third aspect of this invention is based on the first aspect thereof, and provides stereoscopic glasses wherein the second linearly polarized light and the sixth linearly polarized light are different from each other, and the third linearly polarized light and the sixth linearly polarized light are different from each other.

This invention provides the following advantages. The half-wave phase difference plate allows operation of the stereoscopic glasses to be arbitrarily changed between a 3D viewing mode and a 2D viewing mode. The stereoscopic glasses of this invention have a relatively simple structure. The stereoscopic glasses of this invention are inexpensive.

### BRIEF DESCRIPTION OF THE DRAWINGS

FIG. 1 is a diagram of a prior-art stereoscopic video system.

FIG. 2 is a diagram of a stereoscopic video system including stereoscopic glasses according to a first embodiment of this invention.

FIG. 3(a) is a perspective view of a first example of the stereoscopic glasses in FIG. 2 where a half-wave plate is in its unused position.

FIG. 3(b) is a perspective view of a second example of the stereoscopic glasses in FIG. 2 where a half-wave plate is in its unused position.

FIG. 3(c) is a perspective view of the stereoscopic glasses in FIG. 3(a) or the stereoscopic glasses in FIG. 3(b) where the half-wave plate is in its used position.

FIG. 4 is a time-domain diagram of the states of a video signal, a sync signal, a left-eye liquid crystal device, and a right-eye liquid crystal device in the prior-art stereoscopic video system of FIG. 1.

FIG. 5 is a block diagram of prior-art stereoscopic glasses.

FIG. 6 is a time-domain diagram of the state of a video signal, and pictures reaching viewer's left eye and right eye in connection with the prior-art stereoscopic glasses in FIG. 5.

FIG. 7 is a block diagram of stereoscopic glasses according to a second embodiment of this invention.

FIG. 8 is a perspective view of the stereoscopic glasses in FIG. 7.

FIG. 9 is a time-domain diagram of the state of a video signal, and pictures reaching viewer's left eye and right eye in connection with a 2D mode of operation of the stereoscopic glasses in FIG. 7.

### DETAILED DESCRIPTION OF THE INVENTION

### First Embodiment

A prior-art stereoscopic video system will be explained below for a better understanding of this invention.

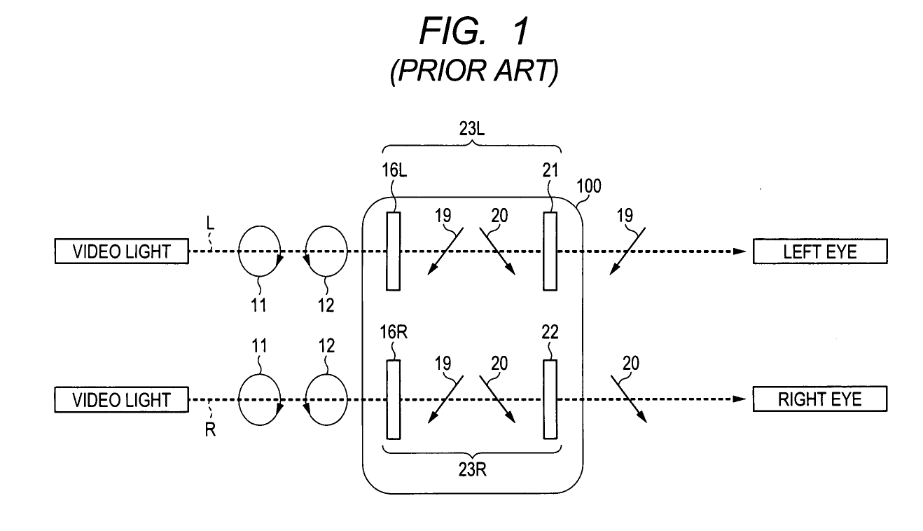

With reference to FIG. 1, a prior-art stereoscopic video system includes stereoscopic or 3D (three-dimensional) glasses 100. There are video light 11 for viewer's left eye and video light 12 for viewer's right eye. One of the video light 11 and the video light 12 is right-handed circularly polarized (clockwise circularly polarized), and the other is left-handed circularly polarized (counter-clockwise circularly polarized). The video light 11 and the video light 12 are incident to the stereoscopic glasses 100.

The stereoscopic glasses 100 have a polarization-converting optical system 23L for viewer's left eye and a polarization-converting optical system 23R for viewer's right eye. The optical system 23L consists of a quarter-wave plate (a quarter-wave phase difference plate) 16L and a polarizer 21 following the plate 16L as viewed in a video light travel direction. The optical system 23R consists of a quarter-wave plate 16R and a polarizer 22 following the plate 16R as viewed in a video light travel direction.

The left-eye video light 11 and the right-eye video light 12 travel along an optical path L for viewer's left eye and an optical path R for viewer's right eye. The optical path L extends through the quarter-wave plate 16L and the polarizer 21. The optical path R extends through the quarter-wave plate 16R and the polarizer 22.

The left-eye video light 11 and the right-eye video light 12, which travel along the left-eye optical path L, enter the quarter-wave plate 16L before being converted by the quarter-wave plate 16L into linearly polarized video light 19 for viewer's left eye and linearly polarized video light 20 for viewer's right eye, respectively. The direction of polarization of the light 19 and that of the light 20 are perpendicular to each other.

In the optical system 23L, the linearly polarized video light 19 and the linearly polarized video light 20 meet the polarizer 21. The linearly polarized video light 19 passes through the polarizer 21 while the linearly polarized video light 20 is blocked by the polarizer 21. In other words, the polarizer 21 transmits the left-eye video light 19 only. Therefore, only the left-eye video light 19 is outputted from the optical system 23L before reaching viewer's left eye.

The left-eye video light 11 and the right-eye video light 12, which travel along the right-eye optical path R, enter the quarter-wave plate 16R before being converted by the quarter-wave plate 16R into linearly polarized video light 19 for viewer's left eye and linearly polarized video light 20 for viewer's right eye, respectively. The direction of polarization of the light 19 and that of the light 20 are perpendicular to each other.

In the optical system 23R, the linearly polarized video light 19 and the linearly polarized video light 20 meet the polarizer 22. The linearly polarized video light 20 passes through the polarizer 22 while the linearly polarized video light 19 is blocked by the polarizer 22. In other words, the polarizer 22 transmits the right-eye video light 20 only. Therefore, only the right-eye video light 20 is outputted from the optical system 23L before reaching viewer's right eye.

Accordingly, viewer's left eye is exposed to the left-eye video light 19 only while viewer's right eye is exposed to the right-eye video signal 20 only. Thus, the viewer observes 3D images represented by the video light 19 and the video light 20.

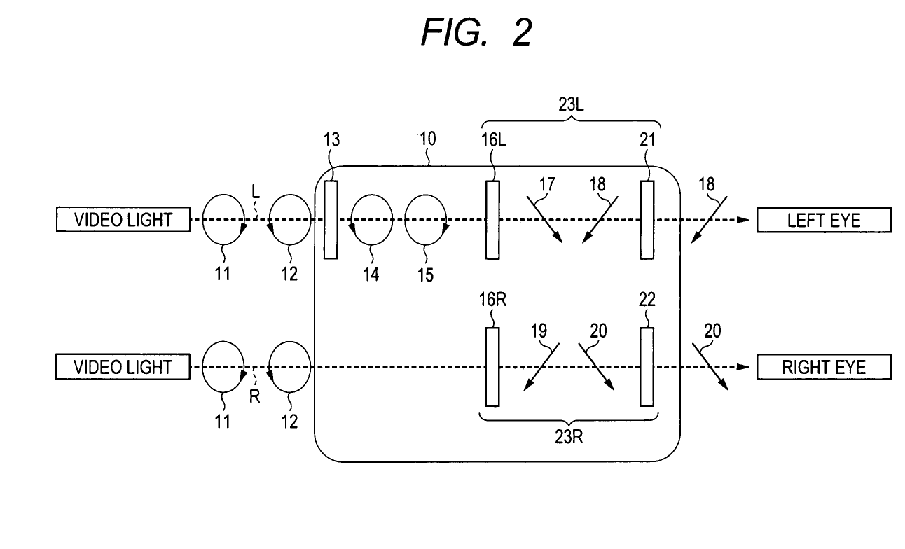

FIG. 2 shows a stereoscopic video system which is similar to the system of FIG. 1 except that the stereoscopic glasses 100 is replaced by stereoscopic or 3D glasses 10 according to a first embodiment of this invention.

Similarly to the stereoscopic glasses 100, the stereoscopic glasses 10 have a polarization-converting optical system 23L for viewer's left eye and a polarization-converting optical system 23R for viewer's right eye. The optical system 23L consists of a quarter-wave plate (a quarter-wave phase difference plate) 16L and a polarizer 21 following the plate 16L as viewed in a video light travel direction. The optical system 23R consists of a quarter-wave plate 16R and a polarizer 22 following the plate 16R as viewed in a video light travel direction.

The stereoscopic glasses 10 further have a half-wave plate (a half-wave phase difference plate) 13. The half-wave plate 13 can be moved by the viewer between a used position and an unused position. When assuming the used position, the half-wave plate 13 is interposed in the left-eye optical path L and precedes the quarter-wave plate 16L as viewed in the video light travel direction. When assuming the unused position, the half-wave plate 13 is sufficiently separate from the left-eye optical path L. As will be made clear later, operation of the stereoscopic glasses 10 is in a 2D (two-dimensional) mode when the half-wave plate 13 assumes its used position. Operation of the stereoscopic glasses 10 is in a 3D mode when the half-wave plate 13 assumes its unused position. The viewer can change operation of the stereoscopic glasses 10 between the 2D mode and the 3D mode by moving the half-wave plate 13 between its used position and its unused position.

It should be noted that the half-wave plate 13 may be placed in connection with the right-eye optical path R rather than the left-eye optical path L.

A description will be made below as to the 2D mode of operation of the stereoscopic glasses 10 in which the half-wave plate 13 assumes its used position and is interposed in the left-eye optical path L.

During the 2D mode of operation, the circularly polarized video light 11 for viewer's left eye and the circularly polarized video light 12 for viewer's right eye, which travel along the left-eye optical path L, enter the half-wave plate 13 before being converted by the half-wave plate 13 into circularly polarized video light 14 for viewer's left eye and circularly polarized video light 15 for viewer's right eye, respectively. The direction of rotation concerning the circular polarization of the video light 11 is reversed by the half-wave plate 13. Therefore, the direction of rotation concerning the circular polarization of the video light 11 and that of the video light 14 are opposite to each other. On the other hand, the direction of rotation concerning the circular polarization of the video light 14 is the same as that of the right-eye video light 12. Similarly, the direction of rotation concerning the circular polarization of the video light 12 is reversed by the half-wave plate 13. Therefore, the direction of rotation concerning the circular polarization of the video light 12 and that of the video light 15 are opposite to each other. On the other hand, the direction of rotation concerning the circular polarization of the video light 15 is the same as that of the left-eye video light 11.

The circularly polarized video light 14 and the circularly polarized video light 15, which travel along the left-eye optical path L, enter the quarter-wave plate 16L before being converted by the quarter-wave plate 16L into linearly polarized video light 17 for viewer's left eye and linearly polarized video light 18 for viewer's right eye, respectively. The direction of polarization of the light 17 and that of the light 18 are perpendicular to each other.

In the optical system 23L, the linearly polarized video light 17 and the linearly polarized video light 18 meet the polarizer 21. The linearly polarized video light 18 passes through the polarizer 21 while the linearly polarized video light 17 is blocked by the polarizer 21. In other words, the polarizer 21 transmits the right-eye video light 18 only. Therefore, only the right-eye video light 18 is outputted from the optical system 23L before reaching viewer's left eye.

During the 2D mode of operation, the left-eye video light 11 and the right-eye video light 12, which travel along the right-eye optical path R, enter the quarter-wave plate 16R before being converted by the quarter-wave plate 16R into linearly polarized video light 19 for viewer's left eye and linearly polarized video light 20 for viewer's right eye, respectively. The direction of polarization of the light 19 and that of the light 20 are perpendicular to each other.

In the optical system 23R, the linearly polarized video light 19 and the linearly polarized video light 20 meet the polarizer 22. The linearly polarized video light 20 passes through the polarizer 22 while the linearly polarized video light 19 is blocked by the polarizer 22. In other words, the polarizer 22 transmits the right-eye video light 20 only. Therefore, only the right-eye video light 20 is outputted from the optical system 23R before reaching viewer's right eye.

Thus, during the 2D mode of operation, viewer's left eye is exposed to the right-eye video light 18 only while viewer's right eye is exposed to the right-eye video light 20 only. Images represented by the video light 18 are the same as those represented by the video light 20. Thus, the viewer observes 2D images represented by the video light 18 and the video light 20.

The viewer can change operation of the stereoscopic glasses 10 from the 2D mode to the 3D mode by moving the half-wave plate 13 to its unused position. Operation of the stereoscopic glasses 10 in the 3D mode is similar to operation of the stereoscopic glasses 100 (see FIG. 1).

During the 3D mode of operation, the half-wave plate 13 assumes its unused position and is sufficiently separate from the left-eye optical path L. Thus, the left-eye video light 11 and the right-eye video light 12, which travel along the left-eye optical path L, directly enter the quarter-wave plate 16L without meeting the half-wave plate 13.

During the 3D mode of operation, only the left-eye video light 19 is outputted from the optical system 23L before reaching viewer's left eye (see FIG. 1). In addition, only the right-eye video light 20 is outputted from the optical system 23R before reaching viewer's right eye. Thus, the viewer observes 3D images represented by the video light 19 and the video light 20.

The viewer can change operation of the stereoscopic glasses 10 from the 3D mode to the 2D mode by moving the half-wave plate 13 to its used position. The change to the 2D mode from the 3D mode is good to a viewer who is suffering from 3D sickness.

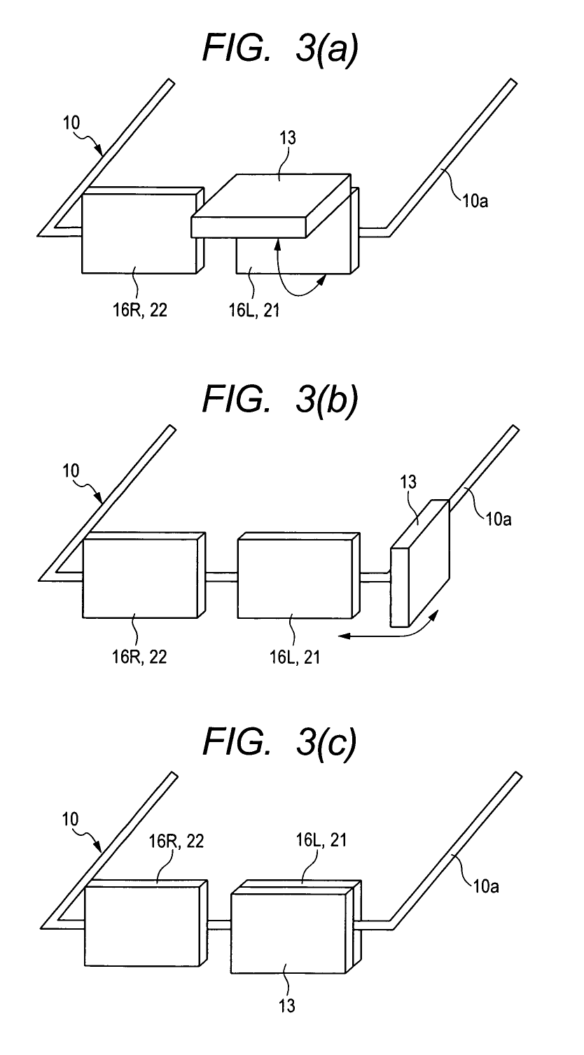

FIG. 3(a) shows a first example of the stereoscopic glasses 10 in which the half-wave plate 13 is connected to the quarter-wave plate 16L via a hinge. The half-wave plate 13 can be swung relative to the quarter-wave plate 16L between its used position and its unused position. In FIG. 3(a), the half-wave plate 13 assumes its unused position where the quarter-wave plate 16L is uncovered. When the half-wave plate 13 is in its used position, the quarter-wave plate 16L is covered by the half-wave plate 13 as shown in FIG. 3(c). It should be noted that the half-wave plate 13 may be connected to a frame 10a of the stereoscopic glasses 10 rather than the quarter-wave plate 16L. In the case where the quarter-wave plate 16L and the polarizer 21 are combined to constitute a single component, the half-wave plate 13 may be connected to the component.

FIG. 3(b) shows a second example of the stereoscopic glasses 10 in which the half-wave plate 13 is connected to the frame 10a via a guide. The half-wave plate 13 can be slid relative to the frame 10a between its used position and its unused position. In FIG. 3(b), the half-wave plate 13 assumes its unused position where the quarter-wave plate 16L is uncovered. When the half-wave plate 13 is in its used position, the quarter-wave plate 16L is covered by the half-wave plate 13 as shown in FIG. 3(c).

### Second Embodiment

Another prior-art stereoscopic video system will be explained below for a better understanding of this invention.

FIG. 5 shows stereoscopic or 3D glasses 300 in a prior-art stereoscopic video system designed so that a display therein alternately emits video light for viewer's left eye and video light for viewer's right eye on a time sharing basis.

The stereoscopic glasses 300 include a left-eye liquid crystal (LC) device 31 and a right-eye liquid crystal device 32. The liquid crystal device 31 serves as a shutter for viewer's left eye. The liquid crystal device 32 serves as a shutter for viewer's right eye.

The liquid crystal device 31 can be changed between a clear or transparent state (an open state) and an opaque state (a closed state). The liquid crystal device 31 assumes the clear state and the opaque state when being subjected to a high-level voltage and a low-level voltage, respectively.

Similarly, the liquid crystal device 32 can be changed between a clear or transparent state and an opaque state. The liquid crystal device 32 assumes the clear state and the opaque state when being subjected to a high-level voltage and a low-level voltage, respectively.

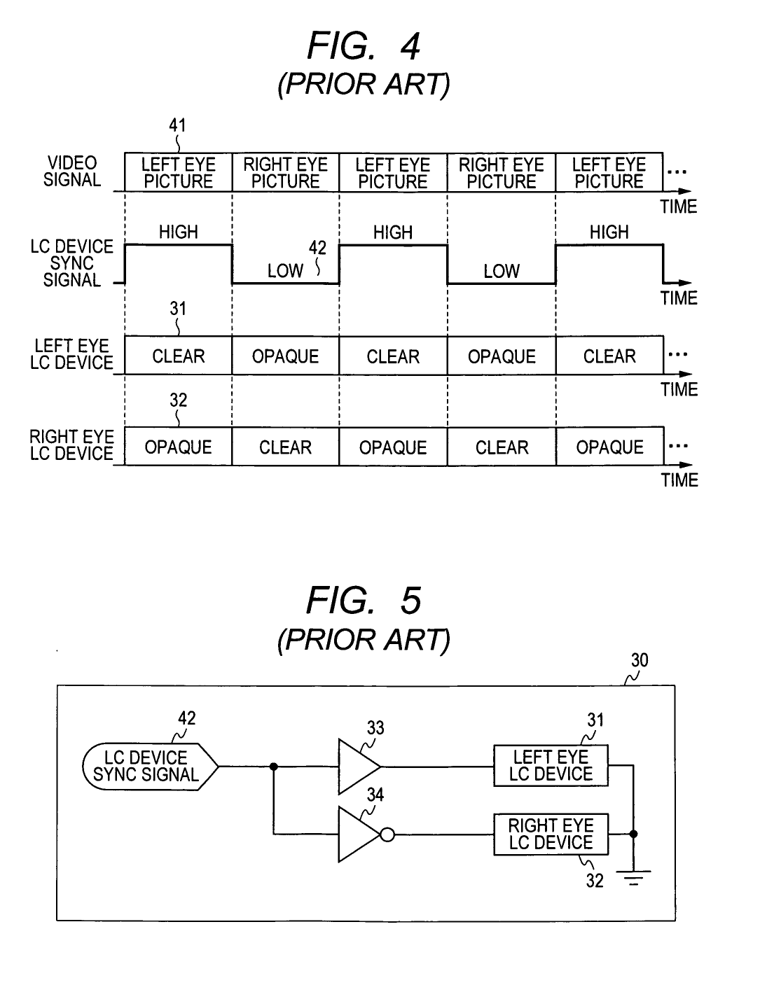

The prior-art stereoscopic video system generates a video signal 41 which represents a stream of pictures for viewer's left eye and a stream of pictures for viewer's right eye in a manner such that the left-eye pictures and the right-eye pictures alternate on a time sharing basis as shown in FIG. 4. A sync signal 42 changes between a high-level state and a low-level state in synchronism with the video signal 41 as shown in FIG. 4. Specifically, the sync signal 42 is in the high-level state when the video signal 41 represents a left-eye picture. The sync signal 42 is in the low-level state when the video signal 41 represents a right-eye picture.

The sync signal 42 is applied to the liquid crystal device 31 through a buffer 33 as a drive signal therefor. The sync signal 42 is inverted by an inverter 34. The inversion of the sync signal 42 is applied to the liquid crystal device 32 from the inverter 34 as a drive signal therefor.

When the video signal 41 represents a left-eye picture so that the display emits left-eye video light, the sync signal 42 applied to the left-eye liquid crystal device 31 is in the high-level state and the inversion of the sync signal 42 which is applied to the right-eye liquid crystal device 32 is in the low-level state. The high-level sync signal 42 forces the left-eye liquid crystal device 31 to be in the clear state. The low-level inversion of the sync signal 42 forces the right-eye liquid crystal device 32 to be in the opaque state. Therefore, in this case, the emitted left-eye video light is blocked by the right-eye liquid crystal device 32 and passes only through the left-eye liquid crystal device 31 before reaching viewer's left eye.

When the video signal 41 represents a right-eye picture so that the display emits right-eye video light, the sync signal 42 is in the low-level state and the inversion of the sync signal 42 is in the high-level state. The low-level sync signal 42 forces the left-eye liquid crystal device 31 to be in the opaque state. The high-level inversion of the sync signal 42 forces the right-eye liquid crystal device 32 to be in the clear state. Therefore, in this case, the emitted right-eye video light is blocked by the left-eye liquid crystal device 31 and passes only through the right-eye liquid crystal device 32 before reaching viewer's right eye.

Accordingly, viewer's left eye is exposed to the left-eye video light only while viewer's right eye is exposed to the right-eye video light only. Thus, the viewer observes 3D images represented by the left-eye video light and the right-eye video light.

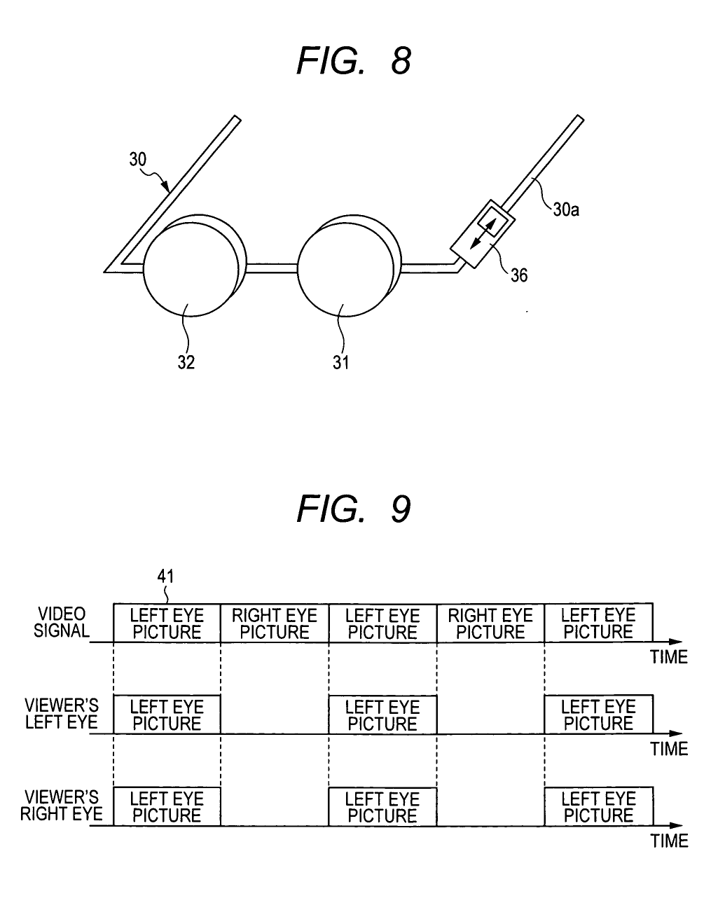

FIGS. 7 and 8 show stereoscopic or 3D glasses 30 according to a second embodiment of this invention. The stereoscopic glasses 30 can replace the stereoscopic glasses 300 (see FIG. 5).

Similarly to the stereoscopic glasses 300, the stereoscopic glasses 30 include a left-eye liquid crystal device 31, a right-eye liquid crystal device 32, a buffer 33, and an inverter 34. The stereoscopic glasses 30 further include a buffer 35 and a switch 36 which can be actuated by the viewer. Preferably, the switch 36 is mounted on a frame 30a of the stereoscopic glasses 30 as shown in FIG. 8.

With reference to FIG. 7, the input terminal of the buffer 35 is subjected to the sync signal 42. The switch 36 selectively connects the right-eye liquid crystal device 32 to either the output terminal of the inverter 34 or the output terminal of the buffer 35. When the switch 36 is actuated by the viewer to connect the right-eye liquid crystal device 32 to the output terminal of the inverter 34, operation of the stereoscopic glasses 30 is in a 3D mode. When the switch 36 is actuated by the viewer to connect the right-eye liquid crystal device 32 to the output terminal of the buffer 35, operation of the stereoscopic glasses 30 is in a 2D mode.

During the 3D mode of operation, the switch 36 connects the right-eye liquid crystal device 32 to the output terminal of the inverter 34 so that the inversion of the sync signal 42 is applied to the right-eye liquid crystal device 32. In this case, the stereoscopic glasses 30 operates similarly to the stereoscopic glasses 300 (see FIG. 5).

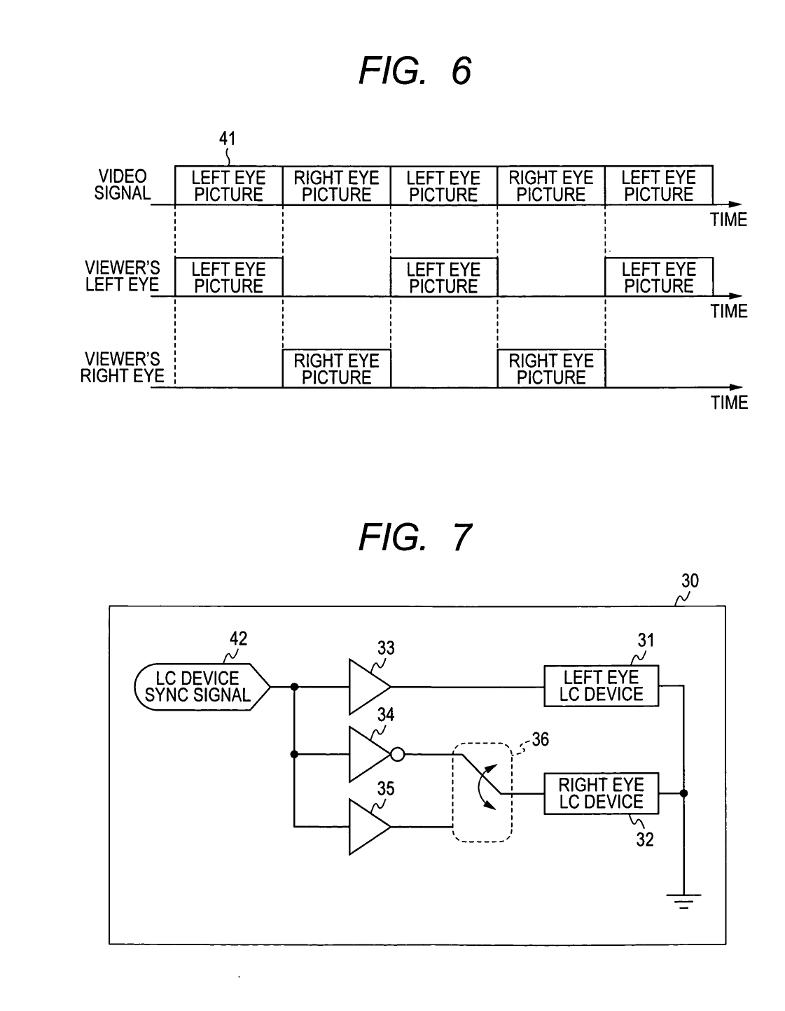

With reference to FIG. 6, during the 3D mode of operation, when the video signal 41 represents a left-eye picture, only viewer's left eye is exposed to the video light representing the left-eye picture. When the video signal 41 represents a right-eye picture, only viewer's right eye is exposed to the video light representing the right-eye picture. Therefore, the viewer observes 3D images represented by the left-eye video light and the right-eye video light.

During the 2D mode of operation, the switch 36 connects the right-eye liquid crystal device 32 to the output terminal of the buffer 35 so that the sync signal 42 is applied to the right-eye liquid crystal device 32. In this case, when the video signal 41 represents a left-eye picture so that the display emits left-eye video light, the sync signal 42 applied to the left-eye liquid crystal device 31 and the right-eye liquid crystal device 32 is in the high-level state. The high-level sync signal 42 forces the left-eye liquid crystal device 31 and the right-eye liquid crystal device 32 to be in the clear states. Therefore, the emitted left-eye video light passes through both the left-eye liquid crystal device 31 and the right-eye liquid crystal device 32 before reaching viewer's left eye and viewer's right eye.

During the 2D mode of operation, when the video signal 41 represents a right-eye picture so that the display emits right-eye video light, the sync signal 42 is in the low-level state. The low-level sync signal 42 forces the left-eye liquid crystal device 31 and the right-eye liquid crystal device 32 to be in the opaque states. Therefore, the emitted right-eye video light is blocked by both the left-eye liquid crystal device 31 and the right-eye liquid crystal device 32. Accordingly, the right-eye video light is prevented from reaching viewer's left eye and viewer's right eye.

With reference to FIG. 9, during the 2D mode of operation, when the video signal 41 represents a left-eye picture, both viewer's left eye and viewer's right eye are exposed to the video light representing the left-eye picture. When the video signal 41 represents a right-eye picture, neither viewer's left eye nor viewer's right eye is exposed to the video light representing the right-eye picture. Therefore, the viewer observes 2D images represented by the left-eye video light.

During the 2D mode of operation, when the video signal 41 represents a right-eye picture, the emitted right-eye video light is blocked by both the left-eye liquid crystal device 31 and the right-eye liquid crystal device 32. Thus, in this case, both viewer's left eye and viewer's right eye are virtually exposed to a black image. Accordingly, the black image is periodically inserted into or added to a stream of 2D images observed by the viewer. The black-image insertion improves system's moving-picture response.

It should be noted that the stereoscopic glasses 30 may be used in a liquid crystal projector forming a stereoscopic video system. In this case, the above-mentioned advantage provided by the black-image insertion is conspicuous.

What is claimed is:

1. Stereoscopic glasses comprising:
a half-wave phase difference plate movable between a used position and an unused position and reversing a rotational direction of polarization of first circularly polarized light and a rotational direction of polarization of second circularly polarized light to generate third circularly polarized light and fourth circularly polarized light respectively, wherein the rotational direction of polarization of the first circularly polarized light and the rotational direction of polarization of the second circularly polarized light are opposite to each other;
a first polarization-converting optical system exposed to the third circularly polarized light and the fourth circularly polarized light and converting the third circularly polarized light and the fourth circularly polarized light into first linearly polarized light and second linearly polarized light respectively and blocking the first linearly polarized light and outputting the second linearly polarized light when the half-wave phase difference plate is in its used position, and exposed to the first circularly polarized light and the second circularly polarized light and converting the first circularly polarized light and the second circularly polarized light into third linearly polarized light and fourth linearly polarized light respectively and blocking the fourth linearly polarized light and outputting the third linearly polarized light when the half-wave phase difference plate is in its unused position; and
a second polarization-converting optical system converting the first circularly polarized light and the second circularly polarized light into fifth linearly polarized light and sixth linearly polarized light respectively and blocking the fifth linearly polarized light and outputting the sixth linearly polarized light.

2. Stereoscopic glasses as recited in claim 1, wherein each of the first polarization-converting optical system and the second polarization-converting optical system comprises a quarter-wave phase difference plate and a polarizer following the quarter-wave phase difference plate.

3. Stereoscopic glasses as recited in claim 1, wherein the second linearly polarized light and the sixth linearly polarized light are different from each other, and the third linearly polarized light and the sixth linearly polarized light are different from each other.
